(19) United States
(12) Patent Application Publication
(10) Pub. No.: US 2015/0262295 A1
(43) Pub. Date: Sep. 17, 2015

(54) QUADRATIC OPTIMUM TRADING POSITIONS FOR PATH-INDEPENDENT

(71) Applicants: Easwara Naga Subramanian, Madhapur (IN); Sanjay Purushottam Bhat, Madhapur (IN)

(72) Inventors: Easwara Naga Subramanian, Madhapur (IN); Sanjay Purushottam Bhat, Madhapur (IN)

(73) Assignee: Tata Consultancy Services Limited, Mumbai (IN)

(21) Appl. No.: 14/214,258

(22) Filed: Mar. 14, 2014

(51) Int. Cl. G06Q 40/04

(52) U.S. Cl. CPC G06Q 40/04

(57) ABSTRACT

A trading position evaluation system for evaluating trading positions that are globally optimum in market measure includes a trading parameters determination module to determine at a trading time instance from amongst a plurality of trading time instances obtained from a trader, a plurality of trading parameters pertaining to a path-independent European Contingent Claim (ECC) based on ECC data and market data, retrieved from a database. The trading parameters are indicative of information relating to the path-independent ECC. Based on the trading parameters, a position evaluation module evaluates a trading position in the underlying asset at the trading time instance based on the plurality of trading parameters to minimize global variance of profit and loss to the trader.

### TECHNICAL FIELD

The present subject matter relates, in general, to a path-independent European Contingent Claim and, in particular, to a system and a computer-implemented method for evaluating globally optimum trading positions for the path-independent European Contingent Claim in a market measure.

### BACKGROUND

In today's competitive business environment, investment banks make profit by trading financial instruments, such as derivatives. A derivative is a contract between two parties, namely, a buyer and a seller. The seller of the contract is obligated to deliver to the buyer, a payoff that is contingent upon the performance of an underlying asset. In one example, a derivative may be an option written on the underlying asset. The underlying asset may be a stock, a currency, or a commodity. In some derivatives, payoffs have to be delivered at a fixed time to maturity. Such derivatives are in general known as European Contingent Claims (ECC). The ECC may be a European call or put option. Further, the ECC may be a path-independent option, which means its payoff depends on the price of the underlying asset just at the time to maturity.

Selling or buying an option always implies some exposure to financial risk. In case of the European call option, the holder of an option pays a premium to buy the underlying asset at a strike price at the time of maturity of the option. The strike price is the contracted price at which the underlying asset can be purchased or sold at the time of maturity of the option. If the market price of the underlying asset exceeds the strike price, it is profitable for the holder of the option to buy the underlying asset from the option seller, and then sell the underlying asset at the market price to make a profit. Since the European call option provides to its buyer, the right, but not the obligation to buy, the buyer may thus have a chance to make a potentially infinite profit at the cost of losing the amount which he has paid for the option, i.e., the premium. The seller, on the other hand, has an obligation to sell the underlying asset to the holder at the strike price, which may be less than the market price of the underlying asset on the date of maturity of the option. Therefore, for an option seller the amount at risk is potentially infinite due to the uncertain nature of the price of the underlying asset. Thus, option sellers typically use various hedging strategies to minimize such risks.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1 illustrates a network environment implementing a trading position evaluation system, according to an embodiment of the present subject matter.

FIG. 2 illustrates a method for evaluating trading positions for a path-independent European Contingent Claim (ECC) that are globally optimum in a market measure, according to an embodiment of the present subject matter.

### DETAILED DESCRIPTION

The trading of financial instruments, such as a path-independent ECC and other derivatives over computer networks, such as the Internet has become a common activity. Generally, any form of market trading involves a risk and so does the ECC trading. The risk to an ECC buyer is limited to the premium he has paid to an ECC seller. However, the risk to the ECC seller is potentially unlimited, while the profit earned by the ECC seller from the ECC sale alone is limited to the premiums earned. Accordingly, the ECC seller may hedge his risk by trading in the underlying asset of the ECC. The trading decisions taken by the ECC seller constitute the seller's hedging strategy. The net profit/loss incurred by the ECC seller at the time of maturity from selling the ECC and the hedging process is called as the hedging error. The hedging error represents the ECC seller's risk that the ECC seller may incur even after hedging. A judicious choice of a hedging strategy by the ECC seller may lead to a lower residual risk.

Conventional hedging techniques are often postulated on unrealistic assumptions that trades can be made continuously in time. Examples of such hedging techniques include Delta-hedging technique or Black-Scholes hedging techniques. When such techniques are used in realistic settings involving multiple discrete trading time instances, they fail to provide trading positions that are globally optimum, i.e., the trading positions that minimize overall variance on the profit or loss to a trader, for example an ECC seller at the time of maturity in this case. Further, some existing techniques involve large number of parameters and complex calculations, thereby consuming lot of time and effort and are prone to errors.

The calculation of variance requires a choice of probability measure. The probability measure provides the probability of occurrence of different financial events, and represents the quantification of a subjective view of the relative likelihoods of various future events/scenarios. Each market player may use a different probability measure reflecting his or her own subjective views. The collective subjective perception of all the market players is captured by the market probability measure (hereinafter referred to as market measure). Market measures assigns probabilities to financial market spaces based on actual market movements. Though a risk-neutral probability measure is generally used for the purpose of pricing the options, the market measure is the real measure in which the market evolves. Hence, the sellers/traders struggle to minimize the risk in real world, i.e., the market measure.

The present subject matter describes a system and a computer-implemented method for evaluating trading positions for a path-independent European Contingent Claim (ECC) in a market measure. The system as described herein is a trading position evaluation system. In one implementation, trading positions in underlying asset are evaluated at a plurality of discrete time instances starting from the time of initiation till the time of maturity of the ECC. Such trading positions provide minimum global variance of profit/loss to a trader, say, an ECC seller. The term global variance may be understood as variance of overall profit and loss to the trader starting from the time of initiation till the time of maturity of the path-independent ECC.

Initially, a database for storing data associated with the path-independent ECC is maintained according to one implementation. The database can be an external repository associated with the trading position evaluation system, or an internal repository within the trading position evaluation system. In the description hereinafter, a path-independent ECC is referred to as ECC, and the data associated with the path-independent ECC is referred to as ECC data. The ECC data may include the ECC defined by its payoff, time of initiation, time to maturity, premium, price of the underlying asset of the ECC at the time of initiation known as the spot price, strike price of the ECC, and current market prices of call and put options written on the underlying asset of the ECC with the same time to maturity. In one example, the ECC data stored in the database may be obtained from the users, such as traders.

In the above mentioned implementation, the database is further populated with historical data including historical market prices of the underlying asset of the ECC. The historical market prices for the underlying asset can be automatically obtained from a data source, such as National Stock Exchange (NSE) website at regular time intervals, for example, at the end of the day and stored into the database. The data stored in the database may be retrieved whenever the trading positions are to be evaluated. Further, the data contained within such database may be periodically updated, whenever required. For example, new data may be added into the database, existing data can be modified, or non-useful data may be deleted from the database.

In one implementation, rate of return and volatility of the underlying asset of the ECC is computed based on the historical data associated with the underlying asset. To compute the rate of return and the volatility, historical market prices of the underlying asset for a predefined period, say, past two years, are retrieved from the database and log-returns are computed for the underlying asset based on the retrieved historical market prices. Thereafter, log-returns are fitted to a best-fit distribution to generate a plurality of scenarios. The best-fit distribution may be a Normal distribution, a Poisson distribution, a T-distribution, or any other known distribution that fits best to the log-returns. The scenarios, thus generated, may include already existing scenarios that have occurred in the past and other scenarios that have not existed in the past but may have a likelihood of occurring in the future. The scenarios, thus, generated, are fitted to a normal distribution to compute the rate of return and the volatility of the underlying asset. The computed rate of return and the volatility are thereafter annualized.

Further, a risk-free interest rate of the market is computed based upon the retrieved ECC data. The computed annualized rate of return, the annualized volatility and the risk-free interest rate are stored in the database as market data. The database, thus, contains the ECC data, the historical data, and the market data. The data contained in the database can be retrieved by the trading position evaluation system for the purpose of evaluating trading positions. In one implementation, the market data, such as the annualized rate of return, the annualized volatility and the risk-free interest rate can also be computed in real-time during evaluation of the trading position. The manner in which evaluation of trading position takes place is described henceforth.

A trader may provide a plurality of trading time instances starting from the time of initiation till the time of maturity of the ECC as an input to the trading position evaluation system for trading of an underlying asset. Such trading time instances are the discrete time instances at which the trader may trade the underlying asset of the ECC.

Upon receiving trader's input, such as trading time instances, the trading position evaluation system retrieves the ECC data and the market data associated with the underlying asset from the database. For each of the trading time instances specified by the trader, the trading position evaluation system then evaluates a trading position that are globally optimum in the market measure, i.e., the trading position that provides minimum global variance of profit and loss to the trader.

To evaluate the trading position at a particular trading time instance, the trading position evaluation system determines a plurality of trading parameters, pertaining to the ECC, based on the retrieved ECC data and the market data. In one example, the trading parameters includes mean return of the arithmetic-returns of the underlying asset of the ECC, root mean square of the arithmetic-returns of the underlying asset, an accumulated trading gain until a current trading time instance, a scaled option price of the ECC, a shifted scaled option price of the ECC, a term representing the normalized cross-moment between discounted payoff of the ECC and the arithmetic return of the underlying asset of the ECC, and a quadratic approximation price of the ECC at the time of initiation of the ECC. The accumulated trading gain represents the profit or loss accumulated by the trader as a result of the trades performed until the current trading time instance. The quadratic approximation price of the ECC may be understood as a candidate for premium that is exchanged at the time of initiation of the ECC. The scaled option price is the option price computed using a scaled price of the underlying asset of the ECC and the shifted scaled option price may be an option price computed using a shifted scaled price of the underlying asset.

In one implementation, determination of the scaled option price and the shifted scaled option price may take place using any known option pricing method and, in one implementation, may take place using a Black-Scholes pricing method or a Monte-Carlo pricing method. Subsequently, the trading position in the underlying asset is evaluated based on the determined scaled option price and the shifted scaled option price. The trading position conveys to the trader of the ECC, the number of units of the underlying asset to be held by the trader of the ECC at a particular trading time instance until the next trading time instance.

Thus, the trading position evaluated at each of the specified trading time instances starting from the time of initiation of the ECC till the time to maturity when taken together allows the trader to achieve minimum variance of overall profit and loss to the trader, such as an ECC seller, at the time of maturity. As mentioned previously, such a variance of overall profit and loss from the time of initiation to the time of maturity is known as global variance. Thus, minimum global variance of profit and loss can be achieved by evaluating the trading positions at different trading time instances. Therefore, a risk incurred by the trader, especially the ECC seller, is minimized at the time of maturity. The ECC seller, for example, may be able to liquidate the underlying asset at the time of maturity in order to deliver the payoff to the ECC buyer at a minimum risk.

The system and the method described according to the present subject matter, evaluates the trading positions based on a simple analytical closed-form expression, which is provided in the later section. The trading positions evaluated by the system and the method efficiently minimize risk exposure to the traders. Based on the trading positions, a trader would know how many units of the underlying asset should be held at each trading time instance so that the overall risk exposure to the trader is minimized at the time of maturity.

The following disclosure describes a system and a method for evaluating the trading positions for a path-independent European Contingent Claim (ECC) that are globally optimum in the market measure. While aspects of the described system and method can be implemented in any number of different computing systems, environments, and/or configurations, embodiments for the information extraction system are described in the context of the following exemplary system(s) and method(s).

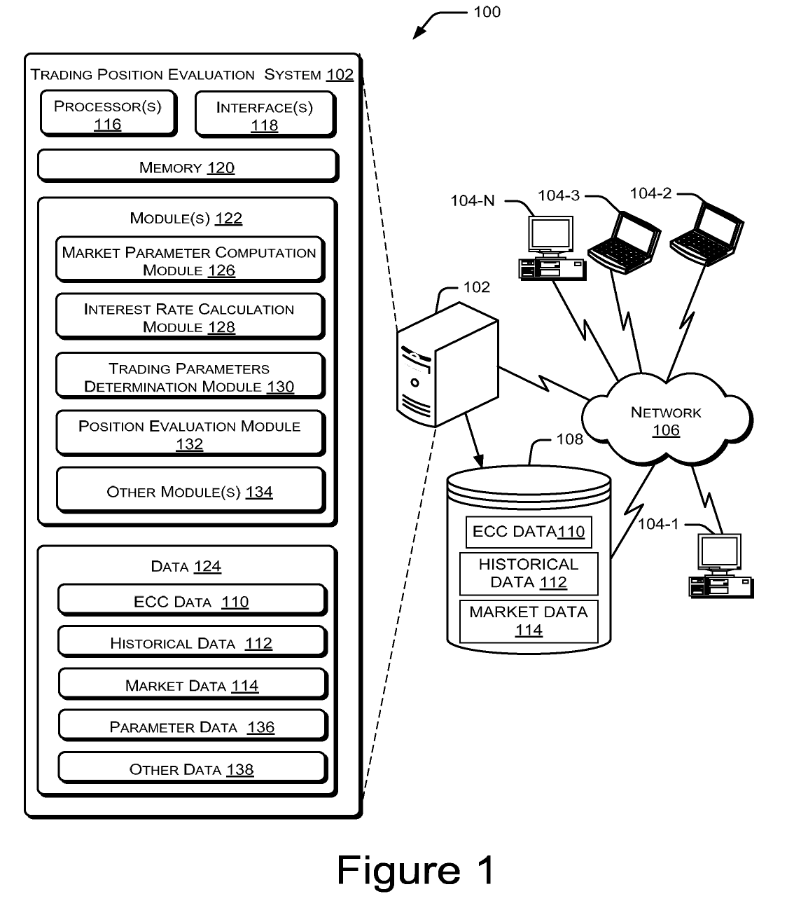

FIG. 1 illustrates a network environment 100 implementing a trading position evaluation system 102, in accordance with an embodiment of the present subject matter. In one implementation, the network environment 100 can be a public network environment, including thousands of personal computers, laptops, various servers, such as blade servers, and other computing devices. In another implementation, the network environment 100 can be a private network environment with a limited number of computing devices, such as personal computers, servers, laptops, and/or communication devices, such as mobile phones and smart phones.

The trading position evaluation system 102 is communicatively connected to a plurality of user devices 104-1, 104-2, 104-3 . . . 104-N, collectively referred to as user devices 104 and individually referred to as a user device 104, through a network 106. In one implementation, a plurality of users, such as traders may use the user devices 104 to communicate with the trading position evaluation system 102.

The trading position evaluation system 102 and the user devices 104 may be implemented in a variety of computing devices, including, servers, a desktop personal computer, a notebook or portable computer, a workstation, a mainframe computer, a laptop and/or communication device, such as mobile phones and smart phones. Further, in one implementation, the trading position evaluation system 102 may be a distributed or centralized network system in which different computing devices may host one or more of the hardware or software components of the trading position evaluation system 102.

The trading position evaluation system 102 may be connected to the user devices 104 over the network 106 through one or more communication links. The communication links between the trading position evaluation system 102 and the user devices 104 are enabled through a desired form of communication, for example, via dial-up modem connections, cable links, digital subscriber lines (DSL), wireless, or satellite links, or any other suitable form of communication.

The network 106 may be a wireless network, a wired network, or a combination thereof. The network 106 can also be an individual network or a collection of many such individual networks, interconnected with each other and functioning as a single large network, e.g., the Internet or an intranet. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, for providing a link between the trading position evaluation system 102 and the user devices 104. The network devices within the network 106 may interact with the trading position evaluation system 102, and the user devices 104 through the communication links.

The network environment 100 further comprises a database 108 communicatively coupled to the trading position evaluation system 102. The database 108 may store all data inclusive of data associated with a path-independent ECC and its underlying asset sold by a trader, interchangeably referred to as an ECC seller in the present description. For example, the database 108 may store ECC data 110, historical data 112, and market data 114. As indicated previously, the ECC data 110 includes, but is not limited to, a path-independent ECC defined by its payoff, time of initiation, time to maturity, premium, spot price of the underlying asset, strike price of the path-independent ECC, and current market prices of the call and put options written on the underlying asset of the path-independent ECC with the same time to maturity. The historical data 112 includes historical market prices of the underlying asset of the path-independent ECC, and the market data 114 includes annualized rate of return of the underlying asset, annualized volatility of the underlying asset, and risk-free interest rate of the market.

Although the database 108 is shown external to the trading position evaluation system 102, it will be appreciated by a person skilled in the art that the database 108 can also be implemented internal to the trading position evaluation system 102, wherein the ECC data 110, the historical data 112, and the market data 114 may be stored within a memory component of the trading position evaluation system 102.

The trading position evaluation system 102 may further include processor(s) 116, interface(s) 118, and memory 120 coupled to the processor(s) 116. The processor(s) 116 may be implemented as one or more microprocessors, microcomputers, microcontrollers, digital signal processors, central processing units, state machines, logic circuitries, and/or any devices that manipulate signals based on operational instructions. Among other capabilities, the processor(s) 116 may fetch and execute computer-readable instructions stored in the memory 120.

Further, the interface(s) 118 may include a variety of software and hardware interfaces, for example, interfaces for peripheral device(s), such as a product board, a mouse, an external memory, and a printer. Additionally, the interface(s) 118 may enable the trading position evaluation system 102 to communicate with other devices, such as web servers and external repositories. The interface(s) 118 may also facilitate multiple communications within a wide variety of networks and protocol types, including wired networks, for example, LAN, cable, etc., and wireless networks, such as WLAN, cellular, or satellite. For the purpose, the interface(s) 118 may include one or more ports.

The memory 120 may include any computer-readable medium known in the art including, for example, volatile memory, such as static random access memory (SRAM), and dynamic random access memory (DRAM), and/or non-volatile memory, such as read only memory (ROM), erasable programmable ROM, flash memories, hard disks, optical disks, and magnetic tapes.

In one implementation, the trading position evaluation system 102 may include module(s) 122 and data 124. The module(s) 122 includes, for example, market parameter computation module 126, an interest rate calculation module 128, a trading parameters determination module 130, a position evaluation module 132, and other module(s) 134. The other module(s) 134 may include programs or coded instructions that supplement applications or functions performed by the trading position evaluation system 102.

The data 124 may include the ECC data 110, the historical data 112, the market data 114, parameter data 136, and other data 138. The ECC data 110 contains data associated with a path-independent European Contingent Claim (ECC). In the description hereinafter, a path-independent ECC is referred to as ECC. The ECC data 110 contains the ECC defined by its payoff, time of initiation, time to maturity of the ECC, its premium, spot price, strike price, and current market price of the call and put options written on an underlying asset of the ECC with the same time to maturity.

The historical data 112 includes historical market prices of the underlying asset of the ECC. The market data 114 includes annualized volatility, annualized rate of return, and risk-free interest rate. The parameter data 136 includes trading parameters, such as mean return of the arithmetic-returns of the underlying asset of the ECC, root mean square of the arithmetic-returns of the underlying asset, an accumulated trading gain until a current trading time instance, a scaled option price of the ECC, a shifted scaled option price of the ECC, a term representing normalized cross-moment between discounted payoff of the ECC and the arithmetic return of the underlying asset of the ECC, and a quadratic approximation price of the ECC at the time of initiation of the ECC. The other data 138, amongst other things, may serve as a repository for storing data that is processed, received, or generated as a result of the execution of one or more modules in the module(s) 122.

In the present embodiment, the ECC data 110, the historical data 112, and the market data 114 are depicted to be stored within the data 124, which is a repository internal to the trading position evaluation system 102. However, as described in the previous embodiment, the ECC data 110, the historical data 112, and the market data 114 may also be stored in the database 108 that is external to the trading position evaluation system 102.

According to the present subject matter, the market parameter computation module 126 retrieves historical data 112 for a predefined period, for example, past one year, from the data 124. As described previously, the historical data 112 includes historical market prices of the underlying asset of the ECC. Based on the retrieved historical data 112, the market parameter computation module 126 computes log-returns of the underlying asset. In one implementation, the market parameter computation module 126 computes the log-returns using the equation (1) provided below:

$${R}_{k} = log \frac{{s}_{k + 1}}{{s}_{k}} , k ∈ \{ 1 , … , m - 1 \} \qquad ( 1 )$$

where,
Rₖ represents a log-return of the underlying asset for kₜₕ period,
Sₖ represents the historical market price of the underlying asset for kₜₕ period, and
m represents a part of the historical data 112.

Subsequent to computing the log-returns, the market parameter computation module 126 may fit the log-returns for the underlying asset to a best-fit distribution. The best-fit distribution may be a Normal distribution, a Poisson distribution, a T-distribution, or any other known distribution that fits best to the log-returns, to generate a plurality of scenarios. The market parameter computation module 126 may then fit the generated scenarios to a normal distribution to compute rate of return (p) and volatility (a) of the underlying asset. The computed volatility and the rate of return of the underlying asset are thereafter annualized. Further, the interest rate calculation module 128 of the trading position evaluation system 102 retrieves the ECC data 110 from the data 124 and computes risk-free interest rate of the market based on the retrieved ECC data 110. According to one implementation, the interest rate calculation module 128 computes the risk-free interest rate using the equation (2) provided below:

$$r = \frac{1}{T} ln \frac{K}{{S}_{0} - C + P} \qquad ( 2 )$$

where,
r represents the risk-free interest rate,
K represents the strike price of the ECC,
T represents the time to maturity,
C and P represent the current market prices of call and put options, and
S₀ represents the spot price of the underlying asset of the ECC.

The annualized volatility (a), the annualized rate of return (p), and risk-free interest rate (r) are stored as the market data 114 and can be retrieved by the trading position evaluation system 102 while evaluating trading positions. Alternatively, the annualized volatility (a), the annualized rate of return (p), and risk-free interest rate (r) may be computed in real-time during evaluation of the trading positions. The manner in which the trading position evaluation system 102 evaluates the trading positions in the underlying asset of the ECC is described henceforth.

The trading position evaluation system 102 receives a plurality of trading time instances from a trader starting from the time of initialization till the time to maturity of the ECC. The trading time instances are the time instances at which the trader would like to trade. In the context of the present subject matter, the trading time instances are mathematically represented by the expression (3).

{T₀,T₁, . . . ,Tₙ} (3)

In the above expression, (T₀) represents the first trading time instance, which is also referred to as time of initiation, and (Tₙ) represents last trading time instance, which is also referred to as time of maturity.

In one implementation, the trading parameters determination module 130 determines a plurality of trading parameters on the ECC data 110 and the market data 114. In said implementation, the trading parameters determination module 130 determines the mean return of the arithmetic-returns of the underlying asset of the ECC and the root mean square of the arithmetic-returns of the underlying asset. The mean return of the arithmetic-returns is mathematically represented by the expression (4) given below.

μ̅ᵢ= [symbol] ᵢ₋₁(Iᵢ),iε{1, . . . ,n} (4)

where,

$${I}_{i} = \frac{{\overline{S}}_{i} - {\overline{S}}_{i - 1}}{{\overline{S}}_{i}} ,$$

iε{1, . . . , n}
where,
μ̅ᵢ represents the mean return of the arithmetic-returns of the underlying asset,
Iᵢ represents arithmetic-returns of the underlying asset,
[symbol] ᵢ₋₁ represents the conditional expectation, and
S̅ᵢ represents discounted price of the underlying asset at trading time Tᵢ.

The root mean square of the arithmetic-returns of the underlying asset is mathematically represented by the expression (5) given below.

v̅ᵢ=\sqrt{ [symbol]ᵢ₋₁(Iᵢ²),}iε{1, . . . ,n} (5)

where,
v̅ᵢ represents the root mean square of the arithmetic-returns of the underlying asset,
Iᵢ represents the arithmetic-returns of the underlying asset, and
[symbol] ᵢ₋₁ represents the conditional expectation.

According to one implementation, the trading parameters determination module 130 may further determine the mean return of the arithmetic-returns of the underlying asset and the root mean square of the arithmetic-returns of the underlying asset using explicit expressions if knowledge of the distribution of the underlying asset is known. For example, if the log-returns values of the underlying asset follow a normal distribution, then the trading parameters determination module 130 determines the mean return of the arithmetic-returns using the equation (6) provided below:

μ̅ᵢ=(e^{(μ-r)δ}^{ᵢ}−1),iε{1, . . . ,n} (6)

where,
μ̅ᵢ represents the mean return of the arithmetic-returns of the log-returns of the underlying asset,
r represents the risk free interest rate,
μ represents the annualized rate of return of the underlying asset, and
δᵢ represents the time difference between two consecutive trading time instances, where δᵢ=(Tᵢ−Tᵢ₋₁).

Referring to the above example, the trading parameters determination module 130 determines the root mean square of the underlying asset using the equation (7) provided below:

v̅ᵢ={square root over ((e^{ν}^{²}^{δ}^{ᵢ}−1)e^{2(μ-r)δ}^{ᵢ}+(e^{(μ-r)δ}^{ᵢ}−1)},iε{1, . . . n} (7)

where,
v̅ᵢ represents the root mean square of the arithmetic-returns of the underlying asset,
r represents the risk free interest rate,
μ represents the annualized rate of return of the underlying asset,
σ represents the annualized volatility of the underlying asset, and
δᵢ represents the time difference between two consecutive trading time instances.

The trading parameters determination module 130 further determines an accumulated trading gain. In one implementation, the trading parameters determination module 130 determines the accumulated trading gain using equation (8) provided below:

Gₖ₋₁(Δ)=Σᵢ₌₁^{k-1}Δᵢ( S̅ᵢ− S̅ᵢ₋₁),kε{1, . . . n} (8)

where,
Gₖ₋₁(Δ) represents the accumulated trading gain until trading instance k−1, and
S̅ᵢ represents the discounted price of the underlying asset at time Tᵢ, for each iε {0, . . . , n}.

According to an implementation, the trading parameters determination module 130 may also determine a quadratic approximation price (X₀) of the ECC at the time of initiation of the ECC. The quadratic approximation price (X₀) of the ECC is the likely premium that can be charged by the seller of the ECC at the time of initiation (T₀) to a prospective buyer of the ECC. During the hedging process, the seller invests the premium that was collected into the trades that are performed at various trading time instances. Thus, the minimization of the global variance of the overall profit and loss incurred at the time of maturity depends on the initial investment and on the trading positions taken at each trading time instance. The quadratic approximation price (X₀) represents the optimal investment that is to be made by the trader at the time of initiation (T₀), and hence an optimal premium to be collected, in order to minimize the overall variance of profit and loss.

In one implementation, the trading parameters determination module 130 may determine the quadratic approximation price (X₀) of the ECC using equation (9) and (10) provided below:

X₀=[Πᵢ₌₁ⁿ(1− μ̅ᵢ²)]⁻¹Σ_{ηε[0,1]}_{ⁿ}e^{(μ-r)δ}^{_{η}}V₀(e^{(μ-r)T}^{ᵢ}e^{σ}^{²}^{δ}^{_{η}}S₀) (9)

where,
X₀ represents the quadratic approximation price of the ECC,
r represents the risk free interest rate,
μ represents the annualized rate of return of the underlying asset,
σ represents the annualized volatility,
V₀(•) represents the price of the ECC at the time of initiation To,
μ̅ᵢ represents the mean return of the arithmetic-returns of the underlying asset, and
S₀ represents the spotprice of the underlying asset of the ECC.

Referring to above equation (9),

$${A}_{i , η} {=}^{Δ} {{Π}_{m = 1}^{n - i} ( 1 + \frac{{\overline{μ}}_{i + m}}{{\overline{v}}_{i + m}} )}^{1 - {η}_{i + m}} {( - \frac{{\overline{μ}}_{i + m}}{{\overline{μ}}_{i + m}} )}^{{η}_{i + m}} , η ∈ {\{ 0 , 1 \}}^{n - i} \qquad ( 10 )$$

The manner in which the term A_{0,η} in equation (9) is evaluated is described henceforth. In equation (11), {0,1}ⁿ is a set of sequence of length n having elements that are either 0 or 1. According to an example, if a trader chooses three trading time instances, i.e, T₀, T₁, and T₂, then we have n=2 (number of trading intervals) and the trading intervals are [T₀, T₁) and [T₁, T₂). In one example, {0,1}ⁿ may be interpreted as representing all possible selections of trading intervals [Tᵢ₋₁, Tᵢ), i={1, . . . , n}. An element ηε {0,1}ⁿ includes the interval [Tᵢ₋₁, Tᵢ) if ηᵢ=1 and excludes the interval if ηᵢ=0, where ηᵢ is the i^{th} element of η. In the above two intervals. The term {0,1}ⁿ has sequences (0, 0), (0, 1), (1, 0), and (1, 1). Therefore, ηε {0,1}ⁿ is one of the above four sequences. Further, we have, δ₁=(T₁−T₀) and δ₂=(T₂−T₁). If δₙ=Σᵢ₌₁ⁿ=1ηᵢδᵢ, then δₙ represents the sum of length of the trading intervals for the selection η.

In one scenario, let η=(0, 1)ε{0,1}ⁿ, then η₁=0 and η₂=0, and δ_{η}=0*δ₁+1*δ₂=δ₂. Similarly, if η=(0, 0), then η₁=η₂=0 and δ_{η}=0. If η=(1, 0), then η₁=1, η₂=0 and δ_{η}=δ₁. Further, if η=(1, 1), then η₁=η₂=1 and δ_{η}=δ₁+δ₂.

Further, consider a term {0, 1}ᵢ^{α} which represents a set of sequences of length a in which first i elements are zero. Let i=1, the term {0, 1}ᵢ^{α} consists of sequences in {0,1}^{α} whose 1^{st} element is zero. Thus, {0,1}ᵢ^{α} for i=1 and a=2, contains (0, 0) and (0, 1) and does not contain (1, 0) and (1, 1). Taking another scenario, where i=0, then a−i=2−0=2, i+m=m for m=1, 2. Then the term A_{0,η} can be evaluated as,

$${A}_{i , η} {=}^{Δ} {{Π}_{m = 1}^{a - i} ( 1 + \frac{{\overline{μ}}_{i + m}}{{\overline{v}}_{i + m}} )}^{1 - {η}_{i + m}} {( - \frac{{\overline{μ}}_{i + m}}{{\overline{v}}_{i + m}} )}^{{η}_{i + m}} {=}^{Δ} {{Π}_{m = 1}^{2} ( 1 + \frac{{\overline{μ}}_{i}}{{\overline{v}}_{i}} )}^{1 - {η}_{m}} {( - \frac{{\overline{μ}}_{i}}{{\overline{μ}}_{i}} )}^{{η}_{m}} {=}^{Δ} {( 1 + \frac{{\overline{μ}}_{1}}{{\overline{v}}_{1}} )}^{1 - {η}_{1}} {( - \frac{{\overline{μ}}_{1}}{{\overline{μ}}_{1}} )}^{{η}_{1}} + {( 1 + \frac{{\overline{μ}}_{2}}{{\overline{v}}_{2}} )}^{1 - {η}_{2}} {( - \frac{{\overline{μ}}_{2}}{{\overline{μ}}_{2}} )}^{{η}_{2}}$$

### Then,

$${Δ}_{i} = - \frac{{\overline{μ}}_{i}}{{\overline{s}}_{i - 1} {\overline{v}}_{i}^{2}} {G}_{k - 1} ( Δ ) - \frac{{\overline{μ}}_{i}}{{\overline{s}}_{i - 1} {\overline{v}}_{i}^{2}} {X}_{0} + \frac{{z}_{i}}{{\overline{s}}_{i - 1} {\overline{v}}_{i}^{2} {Π}_{j = 1 + 1}^{n} ( 1 - {μ}_{j}^{2} )} , i ∈ \{ 1 , … , n \} \qquad ( 14 )$$

Further, in one implementation, at each of the trading time instances, the trading parameters determination module 130 determines the scaled option price and the shifted scaled option price of the ECC based on the ECC data 110 and the market data 114. The scaled option price may be understood as the option price computed using a scaled price of the underlying asset at any given trading time instance. Further, the shifted scaled option price may be understood as the option price computed using a shifted price of the underlying asset at any given trading time instance. In one implementation, the scaled option price and the shifted option price may be determined at trading time Tᵢ₋₁.

In one implementation, the trading parameters determination module 130 may determine the scaled option price and the shifted scaled option price using a Black-Scholes pricing method or a Monte-Carlo pricing method. In the context of the present subject matter, the scaled option price is mathematically represented by the expression (11) given below.

Vᵢ₋₁(e^{(μ-r)(T}^{ₙ}^{-T}^{_{i−1}}⁾e^{σ}^{²}^{δ}^{_{η}}Sᵢ₋₁,iε{1, . . . n} (11)

In the above expression, (Tᵢ₋₁) and (Tₙ) represents the i−1^{th} trading time instance and last trading time instance. The term (e^{(μ-r)(T}^{ₙ}^{-T}^{_{i−1}}⁾e^{σ}^{²}^{δ}^{_{η}}) represents the scaling factor, (μ) represents the annualized rate of return of the underlying asset, (r) represents the risk-free interest rate, and (δ_{η}) represents sum of length of trading intervals.

The shifted scaled option price is mathematically represented by the expression (12) given below.

e^{(μ-r)δ}^{ᵢ}Vᵢ₋₁e^{(μ-r)(T}^{ₙ}^{-T}^{_{i−1}}⁾e^{σ}^{²}^{(δ}^{_{η}}^{+δ}^{ᵢ}⁾Sᵢ₋₁,iε{1, . . . ,n} (12)

In the above expression, (e^{σ}^{²}^{δ}^{ᵢ}) represents the shifting factor, (σ) represents the annualized volatility of the underlying asset, and (δᵢ) represents the time difference between two consecutive trading time instances.

In one implementation, the trading parameters determination module 130 may further determine the term representing the normalized cross-moment between the discounted payoff of the ECC and arithmetic return in the trading interval [Tᵢ₋₁, Tᵢ) using equation (13) provide below

$$if η = ( 0 , 0 ) , then {A}_{i , η} = {A}_{0 , η} {=}^{Δ} ( 1 + \frac{\overline{{μ}_{1}}}{\overline{{v}_{1}}} ) + ( 1 + \frac{\overline{{μ}_{2}}}{\overline{{v}_{2}}} ) , \\ if η = ( 1 , 0 ) , then {A}_{i , η} = {A}_{0 , η} {=}^{Δ} ( - \frac{\overline{{μ}_{1}}}{\overline{{v}_{1}}} ) + ( 1 + \frac{\overline{{μ}_{2}}}{\overline{{v}_{2}}} ) , \\ if η = ( 1 , 1 ) , then {A}_{i , η} = {A}_{0 , η} {=}^{Δ} ( - \frac{\overline{{μ}_{1}}}{\overline{{v}_{1}}} ) + ( - \frac{\overline{{μ}_{2}}}{\overline{{v}_{2}}} ) .$$

where,
Zᵢ represents the normalized cross moment term,
r represents the risk free interest rate,
σ represents the annualized volatility,
μ represents the annualized rate of return of the underlying asset,
Vᵢ₋₁(e^{(μ-r)(T}^{ₙ}^{-T}^{_{i−1}}⁾e^{σ}^{²}^{δ}^{_{η}}Sᵢ₋₁) represents the scaled option price,
e^{(μ-r)δ}^{ᵢ}Vᵢ₋₁e^{(μ-r)(T}^{ₙ}^{-T}^{^{i−1}}⁾e^{(δ}^{_{η}}^{+δ}^{ᵢ}⁾Sᵢ₋₁ represents the shifted scaled option price,
Tᵢ₋₁ represents the time of initiation, and
δᵢ represents the time difference between two consecutive trading time instances.

The trading parameters, such as the mean return of the arithmetic-returns of the underlying asset, the root mean square of the arithmetic-returns of the underlying asset, the accumulated trading gain until a current trading time instance, the scaled option price of the ECC, the shifted scaled option price of the ECC, the term representing the normalized cross-moment between discounted payoff of the ECC and the arithmetic return of the underlying asset of the ECC, and the quadratic approximation price of the ECC determined by the trading parameters determination module 130 may be stored as the parameter data 136 within the trading position evaluation system 102.

Based on the trading parameters, the position evaluation module 132 of the trading position evaluation system 102 evaluates a trading position at each trading time instance from the time of initiation of the ECC till the time to maturity. The trading positions, thus evaluated, are globally optimum in the market measure. As indicated earlier, the trading positions conveys to the trader of the ECC, the number of units of the underlying asset to be held by the trader of the ECC at a particular trading time instance until the next trading time instance. The trading position evaluated at each trading time instance starting from the time of initiation of the ECC till the time to maturity when taken together allows the trader or the seller to achieve minimum global variance of overall profit and loss to the trader at the time of maturity in market measure. Thus, minimum global variance of profit and loss can be achieved by evaluating the trading positions at different trading time instances.

The position evaluation module 132 may compute the trading position at a particular trading time instance using the equation (14) provided below.

$${Z}_{i} = {e}^{- {rT}_{i - 1}} {Σ}_{η ∈ {\{ 0 , 1 \}}_{i + 1}^{n}} {A}_{i , η} {e}^{( μ - r ) {δ}_{η}} \times [ {e}^{( μ - r ) {δ}_{i}} {V}_{i - 1} ( {e}^{( μ - r ) ( {T}_{n} - {T}_{i - 1} )} {e}^{{σ}^{2} ( {δ}_{η} + {δ}_{i} )} {S}_{i - 1} ) - {V}_{i - 1} ( {e}^{( μ - r ) ( {T}_{n} - {T}_{i - 1} )} {e}^{{σ}^{2} {δ}_{η}} {S}_{i - 1} ) ] , i ∈ \{ 1 , … , n \} \qquad ( 13 )$$

where,
Zᵢ represents the normalized cross moment term,
v̅ᵢ represents the root mean square of the arithmetic-returns of the underlying asset,
μ̅ᵢ represents the mean return of the arithmetic-returns of the underlying asset,
S̅ᵢ represents the discounted price of the underlying asset at time Tᵢ,
Gₖ₋₁(Δ) represents the accumulated trading gain until trading instance k−1, and
X₀ represents the quadratic approximation price of the ECC.

The position evaluation module 132 evaluates the trading position at each trading time instance. At the time of maturity, the trader liquidates the computed trading positions and delivers the payoff to the buyer. Taking an example of an ECC, a seller of the ECC gets premium (β) from the buyer and purchases Δ₁ units of the underlying asset at price (S₀) at trading time instance (T₀). Thereafter, at trading time instance (T₁), the seller sells Δ₁ units of the underlying asset at price (S₁) and repurchases Δ₂ units of the underlying asset at price (S₁) and this continues till the time to maturity (Tₙ). The seller then, at the time of maturity (Tₙ) liquates the position, i.e., Δᵢ units of the underlying asset at price (Sₙ) and delivers the payoff (H) to the buyer of the ECC. Thus, according to the present subject matter, the trading positions that are globally optimum in the market measure are evaluated by using a simple analytical closed-form expression, i.e., the equation (14).

Therefore, the trading positions are evaluated by using a simple analytical closed-form expression (14). The evaluated trading positions efficiently minimize risk exposure to the traders. Based on the trading positions, a trader would know how many units of the underlying asset should be held at each trading time instance so that the risk exposure to the trader is minimized.

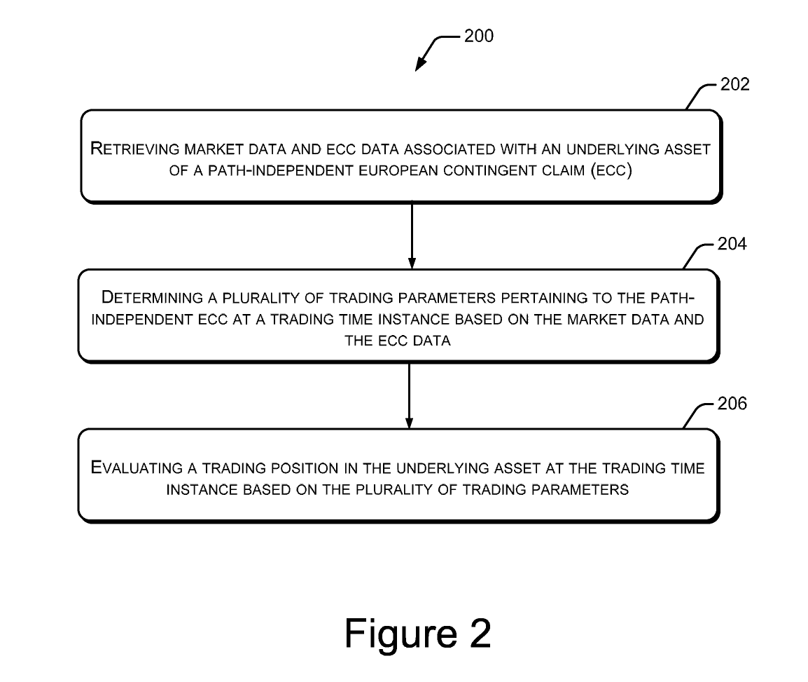

FIG. 2 illustrates a method 200 for evaluating trading positions for a path-independent European Contingent Claim (ECC) that are globally optimum in a market measure, according to an embodiment of the present subject matter. The method 200 is implemented in computing device, such as a trading position evaluation system 102. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network.

The order in which the method is described is not intended to be construed as a limitation, and any number of the described method blocks can be combined in any order to implement the method, or an alternative method. Furthermore, the method can be implemented in any suitable hardware, software, firmware or combination thereof.

At block 202, the method 200 includes retrieving ECC data and market data associated with an underlying asset of a path-independent ECC. The ECC data may include the data associated with the path-independent ECC, such as its payoff (H), time of initiation (T₀), time to maturity (Tₙ), premium (β), spot price (S₀) strike price (K) and current market prices of call and put options written on the underlying asset of the path-independent ECC at same time to maturity. The market data 114 includes annualized rate of return (μ) of the underlying asset, annualized volatility (σ) of the underlying asset, and the risk-free interest rate (r) of the market.

At block 204 of the method 200, a plurality of trading parameters pertaining to the path-independent ECC is determined at a trading time instance, based on the market data and the ECC data. As described previously, the trading parameters may include mean return of the arithmetic-returns of the underlying asset of the path-independent ECC, root mean square of the arithmetic-returns of the underlying asset, an accumulated trading gain until a current trading time instance, a scaled option price of the path-independent ECC, a shifted scaled option price of the path-independent ECC, a term representing normalized cross-moment between discounted payoff of the path-independent ECC and the arithmetic return of the underlying asset of the path-independent ECC, and a quadratic approximation price of the path-independent ECC at a time of initiation of the path-independent ECC. The trading time instance may be provided by a trader of the path-independent ECC. In accordance with one implementation of the present subject matter, the trading parameters determination module 130 determines the trading parameters pertaining to the path-independent ECC.

At block 206 of the method 200, a trading position in the underlying asset at the trading time instance is evaluated based on the plurality of trading parameters. The evaluated trading position is globally optimum in a market measure. Such a trading position is also referred as globally optimum trading position in the present description. In one implementation, the position evaluation module 132 evaluates the globally optimum trading position in the underlying asset based on the equation (14) described in the previous section.

The method blocks 204 and 206 described above are repeated at each of a plurality of trading time instance provided by the trader to evaluate the trading positions at each trading time instance. At the last trading time instance, the trader such as the seller of the path-independent ECC liquidates the underlying asset and delivers the payoff to the buyer in order to minimize the global variance of profit and loss at the time of maturity of the path-independent ECC.

Although embodiments for methods and systems for evaluating trading positions that are globally optimum trading positions in market measure have been described in a language specific to structural features and/or methods, it is to be understood that the invention is not necessarily limited to the specific features or methods described. Rather, the specific features and methods are disclosed as exemplary embodiments for evaluating the globally optimum trading positions in market measure.

I/we claim:

1. A trading position evaluation system comprising:
a processor;
a trading parameters determination module, coupled to the processor, to determine, at a trading time instance from amongst a plurality of trading time instances obtained from a trader, a plurality of trading parameters pertaining to a path-independent European Contingent claim (ECC) based on ECC data and market data, retrieved from a database,
wherein the plurality of trading parameters is indicative of information relating to the path-independent ECC, and
wherein the ECC data comprises data associated with the path-independent ECC and an underlying asset of the path-independent ECC, and the market data comprises annualized rate of return of the underlying asset, annualized volatility of the underlying asset, and risk-free interest rate of market; and
a position evaluation module, coupled to the processor, to evaluate a trading position in the underlying asset at the trading time instance based on the plurality of trading parameters, wherein the trading position minimizes global variance of profit and loss to the trader.

2. The trading position evaluation system as claimed in claim 1, wherein the plurality of trading parameters comprises mean return of arithmetic-returns of the underlying asset of the path-independent ECC, root mean square of the arithmetic-returns of the underlying asset, an accumulated trading gain until a current trading time instance, a scaled option price of the path-independent ECC, a shifted scaled option price of the path-independent ECC, a term representing a normalized cross-moment between discounted payoff of the path-independent ECC and arithmetic return of the underlying asset of the path-independent ECC, and a quadratic approximation price of the path-independent ECC.

3. The trading position evaluation system as claimed in claim 2, wherein the trading parameters determination module determines the mean return of arithmetic-returns of the underlying asset of the path-independent ECC based on the risk-free interest rate, the annualized rate of return of the underlying asset, and time difference between two consecutive trading time instances.

4. The trading position evaluation system as claimed in claim 2, wherein the trading parameters determination module determines the root mean square of the underlying asset based on the risk-free interest rate, the annualized rate of return of the underlying asset, the annualized volatility of the underlying asset, and time difference between two consecutive trading time instances.

5. The trading position evaluation system as claimed in claim 2, wherein the trading parameters determination module determines the quadratic approximation price of the path-independent ECC based the risk-free interest rate, the annualized rate of return of the underlying asset, the annualized volatility of the underlying asset, price of the path-independent ECC at the time of initiation, the mean return of the arithmetic-returns of the underlying asset, and the spot price of the underlying asset.

6. The trading position evaluation system as claimed in claim 2, wherein the trading parameters determination module determines the term representing the normalized cross-moment between discounted payoff of the path-independent ECC and the arithmetic return of the underlying asset of the path-independent ECC based on the risk-free interest rate, the annualized rate of return of the underlying asset, the annualized volatility of the underlying asset, the scaled option price of the path-independent ECC, the shifted scaled option price of the path-independent ECC, time of initiation of the path-independent ECC, and time difference between two consecutive trading time instances.

7. The trading position evaluation system as claimed in claim 1 further comprising a market parameter computation module to:
retrieve historical data of the underlying asset from the database, wherein the historical data comprises historical market prices of the underlying asset;
compute log-returns of the underlying asset based on the historical data;
generate a plurality of scenarios based on fitting the log-returns into a best-fit distribution;
fit the plurality of scenarios to a normal distribution to compute rate of return of the underlying asset and volatility of the underlying asset; and
annualize the rate of return and the volatility to obtain the annualized rate of return and an annualized volatility.

8. The trading position evaluation system as claimed in claim 1, wherein the ECC data comprises time of initiation of the path-independent ECC, time to maturity of the path-independent ECC, premium, spot price of the underlying asset, strike price of the path-independent ECC, and current market price of call and put options written on the underlying asset of the path-independent ECC.

9. The trading position evaluation system as claimed in claim 1 further comprising an interest rate calculation module configured to calculate the risk-free interest rate of the market based on the ECC data.

10. The trading position evaluation system as claimed in claim 7, wherein the best-fit distribution is one of a Normal distribution, a Poisson distribution, and a T-distribution.

11. A computer-implemented method for evaluating trading positions for a path-independent European Contingent claim (ECC) that are quadratic optimum in a market measure, wherein the method comprises:
receiving a plurality of trading time instances from a trader;
retrieving ECC data and market data associated with the path-independent ECC from a database, wherein the ECC data comprises data associated with the path-independent ECC and an underlying asset of the path-independent ECC, and the market data comprises annualized rate of return and annualized volatility of the underlying asset, and risk-free interest rate of market;
determining a plurality of trading parameters pertaining to the path-independent ECC at each of a plurality of trading time instances, based on the ECC data and the market data, wherein the plurality of trading parameters is indicative of information relating to the path-independent ECC; and
evaluating a trading position in the underlying asset at each of the plurality of trading time instances based on the plurality of trading time instances, wherein the trading position minimizes global variance of profit and loss to the trader.

12. The method as claimed in claim 11 further comprising:
retrieving historical data for a predefined period from the database;
evaluating log-returns of the underlying asset based on the historical data;
generating a plurality of scenarios based on fitting the log-returns into a best-fit distribution;
fitting the plurality of scenarios to a normal distribution to compute the rate of return of the underlying asset and the volatility of the underlying asset; and
annualizing the rate of return and the volatility to obtain the annualized rate of return and the annualized volatility.

13. The method as claimed in claim 12, wherein the historical data comprises historical market prices of the underlying asset obtained from a data source.

14. The method as claimed in claim 11, wherein the ECC data comprises time of initiation of the path-independent ECC, time to maturity of the path-independent ECC, premium, spot price of the underlying asset, strike price of the path-independent ECC, and current market price of call and put options written on the underlying asset of the path-independent ECC.

15. The method as claimed in claim 11 further comprising calculating the risk-free interest rate of the market based on the ECC data.

16. A non-transitory computer-readable medium having embodied thereon a computer program for executing a method for evaluating trading positions for a path-independent European Contingent claim (ECC) that are quadratic optimum in a market measure, wherein the method comprises:
receiving a plurality of trading time instances from a trader;
retrieving ECC data and market data associated with the path-independent ECC from a database, wherein the ECC data comprises data associated with the path-independent ECC and an underlying asset of the path-independent ECC, and the market data comprises annualized rate of return and annualized volatility of the underlying asset, and risk-free interest rate of market;
determining a plurality of trading parameters pertaining to the path-independent ECC at each of a plurality of trading time instances, based on the ECC data and the market data, wherein the plurality of trading parameters is indicative of information relating to the path-independent ECC; and
evaluating a trading position in the underlying asset at each of the plurality of trading time instances based on the plurality of trading time instances, wherein the trading position minimizes global variance of profit and loss to the trader.

17. The non-transitory computer-readable medium as claimed in claim 16, wherein the method further comprising:
retrieving historical data for a predefined period from the database;
evaluating log-returns of the underlying asset based on the historical data;
generating a plurality of scenarios based on fitting the log-returns into a best-fit distribution;
fitting the plurality of scenarios to a normal distribution to compute the volatility and the rate of return of the underlying asset; and
annualizing the volatility and the rate of return to obtain the annualized volatility and the annualized rate of return.

18. The non-transitory computer-readable medium as claimed in claim 17, wherein the historical data comprises historical market prices of the underlying asset obtained from a data source.

19. The non-transitory computer-readable medium as claimed in claim 16 further comprising calculating the risk-free interest rate of the market based on the ECC data.
